(19) United States
(12) Patent Application Publication
(10) Pub. No.: US 2006/0082991 A1
(43) Pub. Date: Apr. 20, 2006

(54) Flashlight adaptor for providing alternative direct current power supply to other electronic instruments

(76) Inventor: Frank Hrabal, Lakewood, NJ (US)

Correspondence Address: CLIFFORD G. FRAYNE, 136 DRUM POINT RD, SUITE 7A, BRICK, NJ, 08723, US

(21) Appl. No.: 11/250,863

(22) Filed: Oct. 14, 2005

Related U.S. Application Data
(60) Provisional application No. 60/618,529, filed on Oct. 14, 2004.

(51) Int. Cl. F21L 4/00

(52) U.S. Cl. 362/183; 362/208

(57) ABSTRACT

A flashlight capable of serving as a power source for other portable electrical appliances, the flashlight having a front lens housing and bulb, a power housing secured to the lens housing, the power housing having a plurality of battery cells, and an end cap secured to the power housing, the adaptor means in a first embodiment being a 3/32 mono or stereo jack secured to the exterior body of the flashlight in communication with a pair of contacts interposed with the bulb of the flashlight, the 3/32 mono or stereo jack in communication with an electrical appliance needing power by means of a power cable, a second power cable with adaptor provides a means for recharging the batteries of the flashlight.

### RELATED APPLICATIONS

Applicant claims the benefit of provisional application Ser. No. 60/618,529, filed Oct. 14, 2004.

### BACKGROUND OF THE INVENTION

1. Field of the Invention

The present invention relates to flashlights and in particular to flashlights having an internal battery power source, the invention being an adaptor to the flashlight that allows the flashlight batteries to provide power to other portable electronic instruments, such as cell phones, portable CD players, cameras and video cameras, when their battery supply is low or depleted and alternatively to recharge the internal battery power source of the flashlight.

2. Description of the Prior Art

The common flashlight has as its sole purpose the illumination of an area or space. The flashlight is a common utensil which is found in most households and is often present in an individual's personal vehicle, such as a car or boat. Still further, many professions require the carrying of a flashlight while on duty, such as a policeman, security guard, fireman or the like. A flashlight therefore is normally readily available to an individual whether at home or traveling in their own personal vehicle.

Many people now travel with a variety of other portable electronic equipment, such as cell phones, pagers, CD players, cameras, video cameras, and electronic scheduling devices. All of these items are powered by batteries. The batteries or power source powering these other electronic instruments may be of a specialized shape or design in order to conform to the structure of the electrical instrument. Oftentimes the individual experiences a lack of power as a result of a dead battery or power source in one or more of these electrical instruments at an inopportune time when a replacement battery or a recharge is not readily available. In those instances, the individual must forego usage of the electrical instrument until a battery change can be affected. Applicant incorporates Applicant's U.S. Pat. No. 6,616,300 by reference.

Applicant's adaptor for a common flashlight allows an individual access to a portable power supply to connect to the electrical instrument having a depleted power supply and utilize that electrical instrument for a period of time until the electrical instrument power supply can be replaced or recharged and also allows for the recharge of the power supply to the flashlight itself.

### OBJECTS OF THE INVENTION

An object of the present invention is to provide for a novel adaptor means for a multi-cell flashlight so as to allow connection from the multi-cell flashlight to a battery powered electrical instrument such as a cell phone, camera or CD player, which has a depleted power supply, so as to allow for continued use of the electrical instrument.

A further object of the present invention is to provide for a novel adaptor means for a multi-cell flashlight which does not interfere with the flashlight's intended purpose.

A still further object of the present invention is to provide for a novel adaptor means for a multi-cell flashlight, which allows for the battery power source of the flashlight to be recharged by means of the adaptor.

### SUMMARY OF THE INVENTION

A flashlight capable of serving as a power source for other portable electrical appliances, the flashlight having a front lens housing and bulb, a power housing secured to the lens housing, the power housing having a plurality of battery cells, and an end cap secured to the power housing, the adaptor means in a first embodiment being a 3/32 mono or stereo jack secured to the exterior body of the flashlight in communication with a pair of contacts interposed with the bulb of the flashlight, the 3/32 mono or stereo jack in communication with an electrical appliance needing power by means of a power cable, a second power cable with adaptor provides a means for recharging the batteries of the flashlight.

### BRIEF DESCRIPTION OF THE DRAWINGS

These and other objects of the present invention will become apparent particularly when taken in light of the following illustrations wherein:

FIG. 1 is an exploded view of a typical multi-cell battery flashlight illustrating the adaptor means of the present invention;

FIG. 2 is a perspective view of one embodiment of the 3/32 mono or stereo jack; and

FIG. 3 is a planar view of the accessory cables.

### DETAILED DESCRIPTION OF THE INVENTION

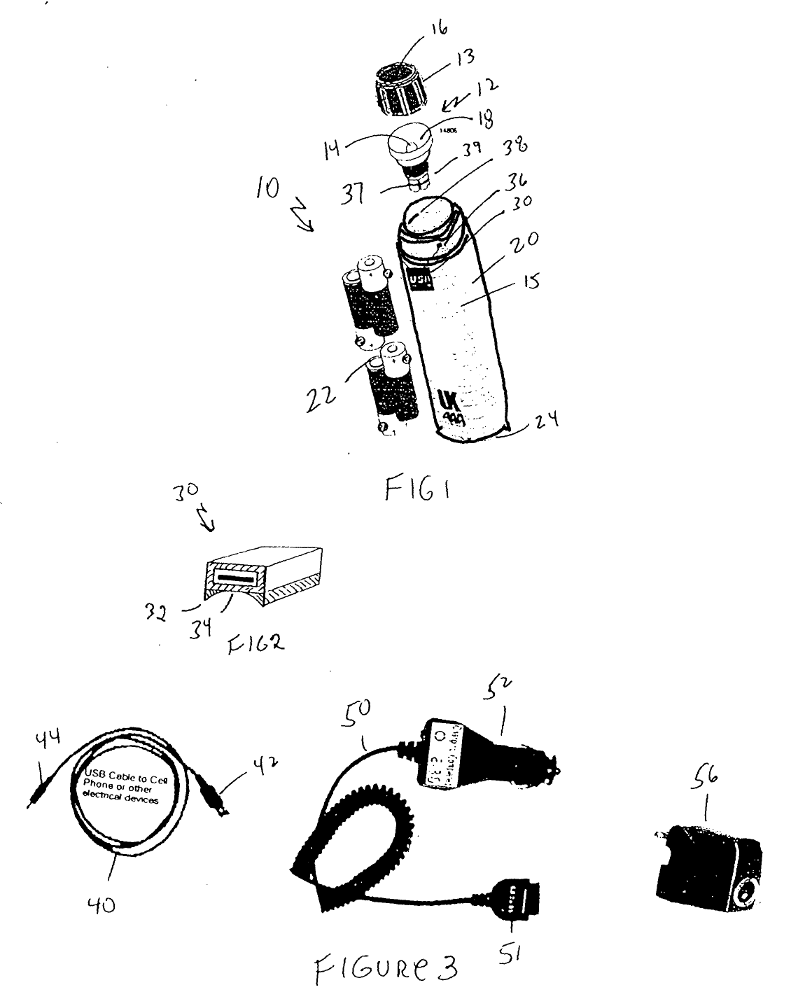

FIG. 1 illustrates a typical flashlight 10 which is comprised of a bulb and lens housing 12 in which there is contained a light bulb 14 and a transparent lens 16. The inner wall 18 of the bulb housing 12 may be coated with a reflective material to enhance the light source. The front of the lens housing 13 is normally threadedly removable. A second portion of the flashlight 10 secured to the lens housing 12 is the tubular power housing 20 which as illustrated in FIG. 1, receives a plurality of batteries or power cells 22. Batteries or power cells 22 may be inserted into power housing 20 by removing lens housing 12 or there may be an end cap 24. End cap 24 is normally threadedly engaged with the opposing end of the power housing 20 with the biasing means serving to insure contact between each of the power cells 22 and light bulb 14 and to effectively complete the circuitry. An on/off button 15 is normally utilized to activate the power source in order to complete the circuitry and cause the light bulb to illuminate.

In FIG. 1, Applicant has adapted a standard multi-cell flashlight, which utilizes any size batteries or rechargeable power cells so as to permit those batteries or power source to be utilized to temporarily power an electrical instrument, such as a cell phone or a portable CD player, when that particular instrument's battery or power source is either low or depleted. It should be noted that while FIG. 1 illustrates a battery array of AA batteries in series, Applicant's invention would have application to other size batteries as well as other types of battery arrangements within the housing.

Applicant's adaptor means, in one embodiment, FIG. 2, is a horizontal mounted 3/32 mono or stereo jack 30 mounted on the exterior power housing 15 of flashlight 10. Since flashlight battery housings come in many shapes and sizes, the 2 pin 3/32 mono or stereo jack 30 would be adaptable to be secured to the exterior housing despite its configuration. Therefore, the lower surface 32 of 3/32 jack 30 could have an arcuate surface 34 as illustrated in FIG. 2 so as adapt to a standard flashlight having a cylindrically-shaped battery housing. However, some batteries come with planar portions of the power housing and in that event, the 3/32 jack 30 utilized would have a planar lower surface. The 3/32 jack 30 would be in electrical communication with a positive contact of the batteries 36 and a negative contact of the batteries 38 in communication with the flashlight on/off switch mounted on the battery housing. Positive contact 36 would be mounted on that portion of the battery housing exterior which receives the lens housing 12. Negative contact 38 in communication with the flashlight on/off switch would be mounted on the interior surface of the battery housing so as to contact a circumferential surface of the lens housing 12. A conductive sleeve 37 is slidably positioned on the rear portion 39 of lens housing 12. In this configuration, a circuit is available for the transfer of power from the batteries or power cells 22 within the flashlight 10 to an electrical appliance having dead or depleted batteries. FIG. 3 illustrates the accessories required in order to conduct the transfer of power to an electrical appliance requiring power and also to recharge the batteries in flashlight 10. A power cable 40 having a 3/32 mono or stereo plug 42 at one end and a suitable plug 44 cooperable with an electrical appliance at the other end, would be utilized to recharge or supply power to the batteries of a depleted electrical appliance. The 3/32 mono or stereo plug 42 would be inserted into the 3/32 mono or stereo jack 30 and the opposing cable end 44 would be inserted into the desired electrical appliance.

A second power cable 50 having a 3/32 mono or stereo jack 51 and adaptor end 52 would be utilized to recharge the batteries or power cells 22 of the flashlight 10. In this configuration the 3/32 mono or stereo plug 51 of cable 50 would be inserted into the 3/32 mono or stereo jack 30 secured to the flashlight 10. The opposing recharger adaptor end 52, could be inserted into an automobile cigarette lighter, an aircraft EM power outlet, or into an AC/DC travel adaptor 56 which could then be inserted into a standard wall outlet. In this configuration the batteries of the flashlight 10 could be recharged.

Applicant has illustrated the adaptor means as being secured to the external surface of the battery between the power source of the flashlight and the lens of the flashlight. In the configuration illustrated, the jack is in a horizontal orientation. The adaptor means could also take the form of a mono or stereo jack mounted between the power source and the lens of the flashlight, but oriented in a vertical position through the casing of the flashlight. Still further, the adaptor means could be positioned within an insert, in a vertical orientation, the insert being secured to the casing of the flashlight between the power source and the lens.

In all of the embodiments, the important feature is that the mono or stereo jack is always in the on, “hot”, mode regardless of whether the flashlight is turned on or off. This allows the battery power source to be utilized for operating the secondary electrical appliance without having to expend power to light the lens of the flashlight.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. An improved flashlight with adaptor to supply power to another battery operated electrical instrument, said flashlight having a lens housing and bulb, a body member for receipt of a plurality of power cells in series, an endcap and a biasing means for maintaining contact between said plurality of power cells and said light bulb, said improvement comprising:
an adaptor means mounted to said body member of said flashlight interposed between said power cells and said lens housing, said adaptor means in communication with said power cells, said adaptor means capable of recharging said power cells from an external power source, said adaptor means capable of providing output power from said power cells to another electrical instrument; said adpator means always conductive.

2. The improved flashlight in accordance with claim 1 wherein said adaptor means is a 3/32 mono or stereo jack.

3. The improved flashlight in accordance with claim 2 wherein said adaptor means is positioned on said body member in a horizontal orientation.

4. The improved flashlight in accordance with claim 2 wherein said adaptor means is positioned on said body member in a vertical orientation.
